(19) United States
(12) Patent Application Publication
(10) Pub. No.: US 2025/0322362 A1
(43) Pub. Date: Oct. 16, 2025

(54) EMPLOYEE TECHNICAL EVOLUTION PROGRESSION VIA DATA ANALYTICS

(71) Applicant: Schlumberger Technology Corporation, Sugar Land, TX (US)

(72) Inventors: Laurent Butre, Paris (FR); Muhsen Al-Qubaisi, Houston, TX (US)

(21) Appl. No.: 19/172,790

(22) Filed: Apr. 8, 2025

Related U.S. Application Data
(60) Provisional application No. 63/633,147, filed on Apr. 12, 2024.

(51) Int. Cl. G06Q 10/105

(52) U.S. Cl. CPC G06Q 10/105

(57) ABSTRACT

A method for helping to assess an employment level or a progression of an employee within an organization includes receiving a technical skill structure of an organization. The technical skill structure includes different employment levels, and the organization includes a plurality of employees that are assigned to the different employment levels. The method also includes receiving interaction data representing interactions between the employees. The interactions occur while the employees perform one or more duties for the organization. The method also includes determining an interaction intensity between the employees during a first time period based upon the interaction data. The method also includes performing an action in response to the interaction intensity.

### CROSS-REFERENCE TO RELATED APPLICATIONS

This application claims priority to U.S. Provisional Patent Application No. 63/633,147, filed on Apr. 12, 2024, which is incorporated by reference.

### BACKGROUND

Many organizations (e.g., companies) have different vertical levels for their employees. Each employee is assigned to one of the levels and may, in the future, be promoted to the next level or demoted to a lower level. The decision to promote is often based upon the (e.g., subjective) determination by a superior or review committee. What is needed is a system and method for making an objective determination of an employee's level based upon a technical evolution progression of the employee.

### SUMMARY

A method for helping to assess an employment level or a progression of an employee within an organization is disclosed. The method includes receiving a technical skill structure of an organization. The technical skill structure includes different employment levels, and the organization includes a plurality of employees that are assigned to the different employment levels. The method also includes receiving interaction data representing interactions between the employees. The interactions occur while the employees perform one or more duties for the organization. The method also includes determining an interaction intensity between the employees during a first time period based upon the interaction data. The method also includes performing an action in response to the interaction intensity.

A computing system is also disclosed. The computing system may include one or more processors and a memory system. The memory system may include one or more non-transitory computer-readable media storing instructions that, when executed by at least one of the one or more processors, cause the computing system to perform operations. The operations may include receiving a technical skill structure of an organization. The technical skill structure includes different employment levels, and the organization comprises a plurality of employees including at least a first employee and a second employee. The employees each have a technical skill level. At least some of the employees are assigned to one of the employment levels based upon their respective technical skill levels. The operations also include receiving interaction data representing interactions between the employees. The interactions occur while the employees perform one or more duties for the organization. The interactions include in-person interactions and/or digital interactions. The in-person interactions include meetings, and the digital interactions include emails and/or typed chats. The interactions occur during a first time period and a second time period. The operations also include determining an interaction intensity between the employees during the first time period based upon the interaction data. The interaction intensity between the first and second employees during the first time period is represented by a first distance between the first and second employees. The first distance is based upon a number of the emails sent from the first employee to the second employee, a number of the typed chats sent from the first employee to the second employee, and a number of hours of the meetings where the first and second employees are both present. The operations also include determining the interaction intensity between the employees during the second time period based upon the interaction data. The interaction intensity between the first and second employees during the second time period is represented by a second distance between the first and second employees. The operations also include comparing the interaction intensity during the first time period to the interaction intensity during the second time period. Comparing the interaction intensity includes comparing the first distance in the first visualization to the second distance in the second visualization. The operations also include performing an action in response to the interaction intensity between the employees during the second time period, the comparison, or a combination thereof.

A non-transitory computer-readable medium is also disclosed. The medium stores instructions that, when executed by one or more processors of a computing system, cause the computing system to perform operations. The operations include receiving a technical skill structure of an organization. The technical skill structure includes different employment levels. The organization includes a plurality of employees including at least a first employee, a second employee, and other employees. The employees each have a technical skill level. At least some of the employees are assigned to one of the employment levels based upon their respective technical skill levels. The other employees are assigned to a higher employment level than the first employee. The operations also include receiving interaction data representing interactions between the employees. The interactions occur while the employees perform one or more duties for the organization. The interactions include in-person interactions and digital interactions. The in-person interactions include meetings. The digital interactions include emails and typed chats. The interactions occur during a first time period and a second time period. The operations also include receiving patent data representing a number of patent applications or patents where each of the employees is listed as an inventor. The operations also include determining an interaction intensity between the employees during the first time period based upon the interaction data. The interaction intensity between the first and second employees during the first time period is represented by a first distance between the first and second employees. The first distance is determined using D=a*X+b*Y+c*Z where D is the first distance, X is a number of the emails sent from the first employee to the second employee, Y is a number of the typed chats sent from the first employee to the second employee, Z is a number of hours of the meetings where the first and second employees are both present, a is a first coefficient, b is a second coefficient that is greater than the first coefficient, and c is a third coefficient that is between the first and second coefficients. X, Y, and Z are normalized based upon a distribution of the interaction data. The operations also include generating a first visualization of the interaction intensity during the first time period. The first visualization shows the first distance between the first and second employees. The technical skill levels of the employees are represented by indicators in the first visualization. The operations also include determining the interaction intensity between the employees during the second time period based upon the interaction data. The interaction intensity between the first and second employees during the second time period is represented by a second distance between the first and second employees. The operations also include generating a second visualization of the interaction intensity during the second time period. The operations also include comparing the interaction intensity during the first time period to the interaction intensity during the second time period. Comparing the interaction intensity includes comparing the first distance in the first visualization to the second distance in the second visualization. Comparing the interaction intensity also includes comparing the indicators in the first visualization to the indicators in the second visualization. The operations also include performing an action in response to the patent data, the interaction intensity between the employees during the second time period, the second visualization, and the comparison.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a visualization of the connection intensity an employee (e.g., Ella) has with her colleagues at a first time (e.g., Time=N), according to an embodiment.

FIG. 2 illustrates a visualization of a technical level of each of the colleagues with which Ella is interacting (e.g., at time N), according to an embodiment.

FIG. 3 illustrates a visualization of the technical level of each of the colleagues with which Ella is interacting at a later time (e.g., time N+1), according to an embodiment.

FIG. 4 illustrates a graph showing the number of hours spent by another employee (e.g., Josselin) in meetings with other “advisor” employees over the last 5 years, according to an embodiment.

FIG. 5 illustrates a graph showing the number of patent applications filed where Josselin (and other employees) were listed as an inventor, according to an embodiment.

FIG. 6 illustrates a flowchart of a method for determining an employee's level based upon a technical evolution progression of the employee, according to an embodiment.

FIGS. 7A-7D illustrate graphs showing a number of users in each category in Table 1, according to an embodiment.

FIGS. 8A-8E illustrate displays showing a ranking of the top ten closest connections for the first employee, according to an embodiment.

FIG. 9 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### Employee Technical Evolution Progression Via Data Analytics

The present disclosure includes a system and method that are configured to automate the assessment process of employees based upon time, connections, and/or identified expert groups. In one embodiment, the system and method may be applied to organizations (e.g., companies) in the oil and gas (O&G) and/or energy industry; however, it may also or instead be applied to other industries. It is based on the concept that a person (e.g., employee) is the average of his/her five closest friends. By introducing the time dimension on the evolution of connections, the true progression of the employee may be predicted or determined. This allows a company (e.g., employer) to identify which expertise group the employee should belong to and more accurately assess his/her skills and potential.

In another embodiment, the system and method may be configured to automatically determine the expertise group to which an employee belongs. This determination may be based upon time, connections, and/or expertise groups. If a company has a progression scale of their collaborators (e.g., senior I, II, III—principal I, II, III—advisor I, II, III—fellow) in the technical and influential aspect, then the time dimension may be introduced on the evolution of connections created, activated, and/or entertained. Then, the true progression of the employee may be predicted or determined. If, over time, the employee's circle of interactions naturally evolves toward a higher recognized level and/or sphere of experts, then the employee may instead belong to that (e.g., different and/or higher) group level.

The prediction(s) and/or determination(s) may be based on the following data dimensions:
Technical skills level structure (e.g., senior, principal, advisor, fellow, with different sublevels)
Employee's connections and interactions with the rest of the organization
Employee's current technical level
Time dimension, to bring the evolution and progression aspect

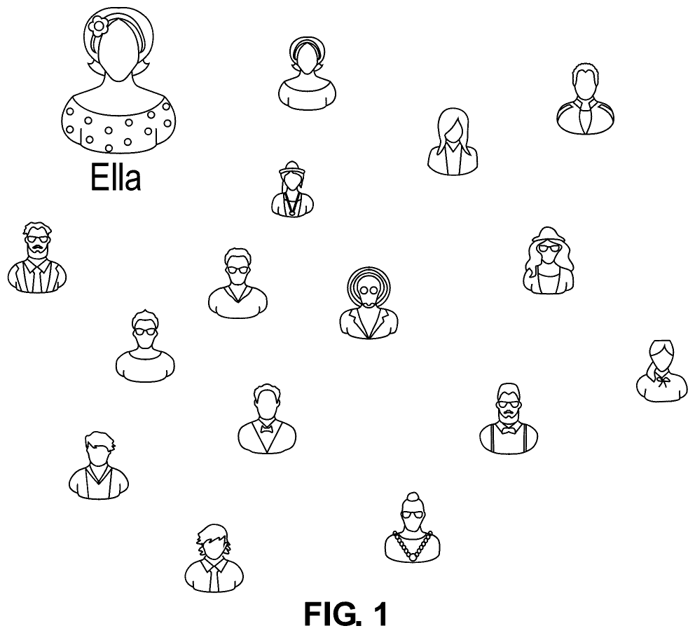

The system and method may first determine a calculation rule to represent interactions between an employee with the rest of the organization. This calculation may take into consideration the digital activity of the employee related to the day-to-day collaboration with other employees. As an example, the intensity of the collaboration with other employees may be represented by the distance in FIGS. 1-3, which are discussed below. FIG. 1 illustrates a visualization of the connection intensity an employee (e.g., Ella) has with her colleagues at a first time (e.g., Time=N), according to an embodiment. The distance between Ella and the colleagues in FIG. 1 may vary directly with the interaction between Ella and the colleagues.

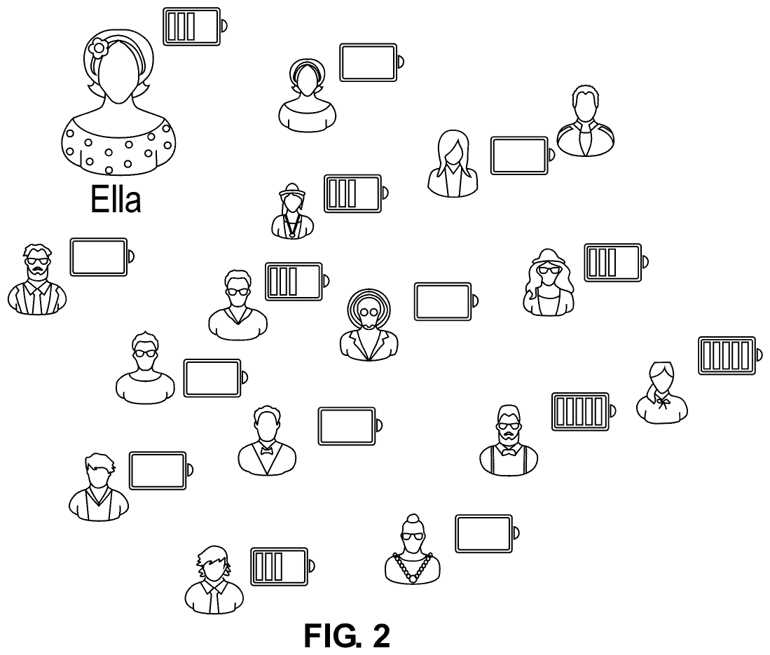

FIG. 2 illustrates a visualization of a technical level of each of the colleagues with which Ella is interacting (e.g., at time N), according to an embodiment. The empty batteries may represent a junior technical level, the partially charged batteries may represent a senior technical level, and the fully charged batteries may represent an advisor (e.g., above the senior technical level). In the example shown in FIG. 2, Ella is mainly collaborating with juniors and seniors. For example, she may be interacting with her peers and acting as a mentor for the juniors.

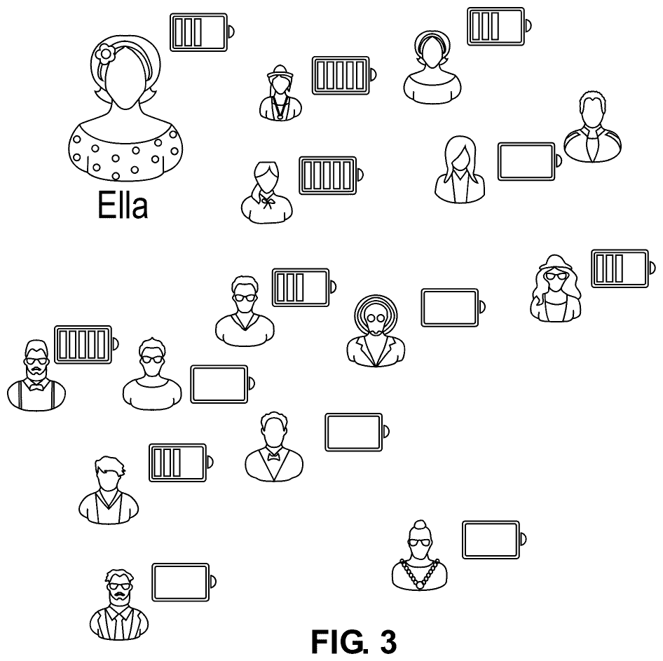

FIG. 3 illustrates a visualization of the technical level of each of the colleagues with which Ella is interacting at a later time (e.g., time N+1), according to an embodiment. Over time, Ella has been working on new challenges, learning new technical skills, influencing more colleagues, and being recognized by a wider or more evolved circle of employees. Comparing FIGS. 2 and 3, it may be observed that Ella has more advisors interacting with her. It may also be seen that that some of the juniors that Ella interacts with have progressed toward the senior technical level. Ella's direct circle of influence is now at a higher technical level. Therefore, based upon the analytics, Ella may deserve to be upgraded to the next level (e.g., advisor). If such observation is performed, it may validate an official status update, or even automatically trigger a consideration promotion in the technical community ranking system.

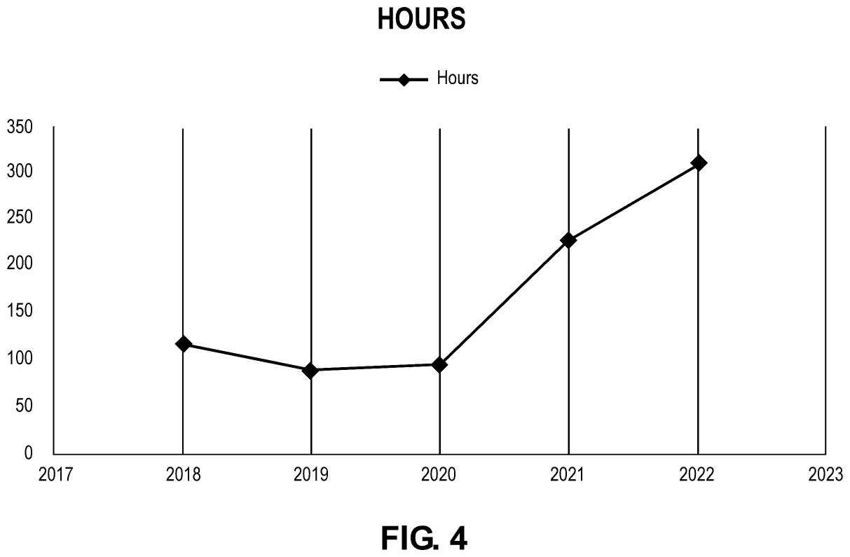

FIG. 4 illustrates a graph showing the number of hours spent by another employee (e.g., Josselin) in meetings with other “advisor” employees over the last 5 years, according to an embodiment. In the example of FIG. 4, Josselin was considered by a committee for an “Advisor” level promotion in 2023. It may be seen that her participation in the next level type of discussion has tripled over the last 3 years of her nomination.

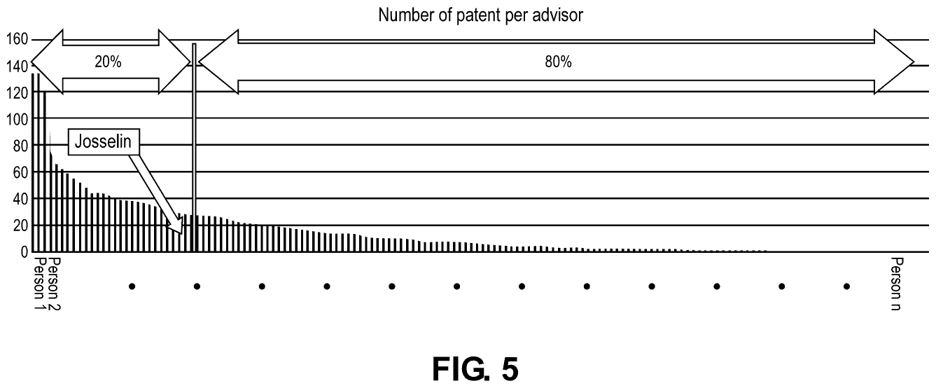

FIG. 5 illustrates a graph showing the number of patent applications filed where Josselin (and other employees) were listed as an inventor, according to an embodiment. The other employees shown in FIG. 5 are from the next (e.g., higher) technical level. It may be seen from this extra data point that Josselin was indeed at the level of “advisor” that she was seeking because she is within the 20% of employees with the highest number of patent applications.

Additional different data points may also be used in this validation such as the amount of communication (e.g., email, calendar meetings, chats). These data points may be compared with the community of peers and higher technical leaders to assess if, over a period of time, an employee has extended his/her reach and become the average of the “5 people you spend most time with.”

The setup may involve data analytics on an employee's technical skill categories, employee's interactions measurements with other employees, timelines of the events to demonstrate the evolution of intensity and spread, or a combination thereof.

This system and method may be used by any organization from any vertical industry which would have a training and development (T&D) program where employees are mapped into levels. Each level progression involving a review committee or assessments may be complemented (or replaced) by this algorithm. If a company has a progression structure for their employees' careers where skill levels and proficiency are accounted, then this algorithm may combine the dimension of time/level/connections with a model of triggers that would allow human resources and managers to justify and validate progressions of their employees. This may reduce the subjectivity of the employee technical progression rewards.

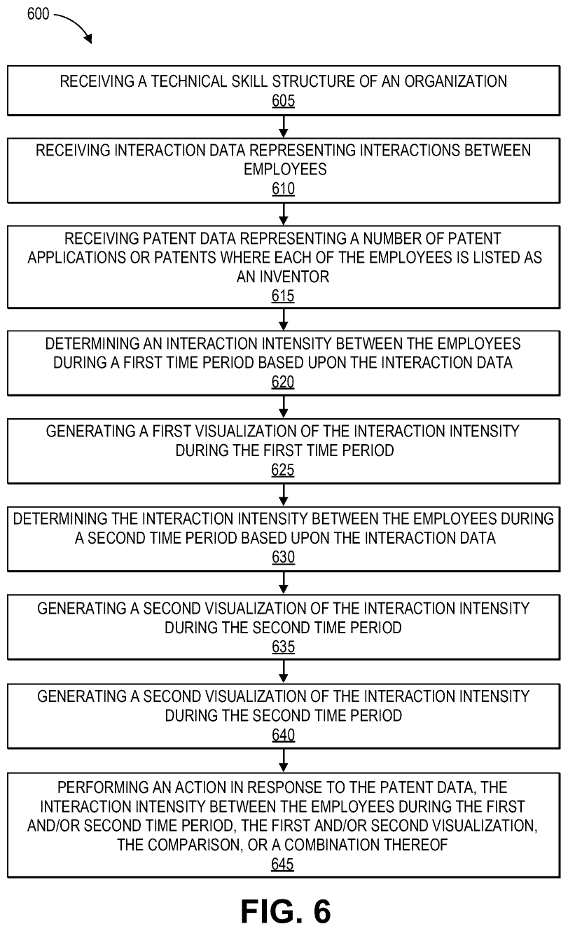

FIG. 6 illustrates a flowchart of a method 600 for helping to automatically and objectively assess an employment level or a progression of an employee within an organization, according to an embodiment. In one embodiment, the method 600 may be used to assess whether an employee's level should be changed (e.g., as a component of the assessment). In another embodiment, the method 600 may be used to prompt such an assessment. In yet another embodiment, the technique may be the assessment. An illustrative order of the method 600 is provided below; however, one or more portions of the method 600 may be performed in a different order, simultaneously, repeated, or omitted. At least a portion of the method 600 may be performed by the computing system 900 (described below).

The method 600 may include receiving a technical skill structure of the organization, as at 605. The technical skill structure may include different employment levels (e.g., junior, senior, principal, advisor, fellow, etc.). In another embodiment, the technical skill structure may also or instead include different levels of progression (e.g., between the levels) in the organization. The organization may include a plurality of employees that each have a technical skill level. At least some of the employees are assigned to one of the employment levels based upon their respective technical skill levels. The employees may include a first employee (e.g., Ella) and other employees. At least some of the other employees may be assigned to a higher employment level than the first employee.

The method 600 may also include receiving interaction data representing interactions between the employees, as at 610. The interactions may occur while the employees are performing one or more duties for the organization (e.g., not social media interactions). The interactions may be or include in-person interactions and/or digital interactions (e.g., on electronic devices). The in-person interactions may be or include meetings. The digital interactions may be or include emails and/or typed chats. The interactions may occur during a plurality of time periods including at least a first time period and a second time period. The second time period may be days, weeks, months, or years after the first time. The interactions may occur between the first employee and the other employees.

The method 600 may also include receiving patent data representing a number of patent applications or patents where each of the employees is listed as an inventor, as at 615. The patent data may be used as a check/confirmation for the level(s) assessed in the method 600. More particularly, if the amount of interaction data and/or interaction intensity data is/are less than a threshold, the patent data may be used to check/confirm that the assessed level appears to be reasonable. In the case of Josselin in FIG. 5, she is in the top 20% of patent applications filed in the organization, which confirms that she should be at a higher level in the organization.

The method 600 may also include determining an interaction intensity between the employees during the first time period based upon the interaction data, as at 620. The interaction intensity between the first and second employees during the first time period may be represented by a first distance between the first and second employees. The first distance may be determined using:

$$D = a * X + b * Y + c * Z$$

where D is the first distance, X is a number of the emails sent from the first employee to the second employee, Y is a number of the typed chats sent from the first employee to the second employee, Z is a number of hours of the meetings where the first and second employees are both present, a is a first coefficient, b is a second coefficient that is greater than the first coefficient, and c is a third coefficient that is between the first and second coefficients.

The variables X, Y, and Z may be normalized based upon a distribution of the interaction data to obtain a spread distribution. After normalization, depending on the number of emails, chats, and/or video, the value of each category may be either 0, 1, 2, 3, 4, or 5. The variables X, Y, and Z may then be multiplied by the corresponding coefficient (e.g., a, b, or c). The coefficients may provide more or less weight to one channel over the other ones. An example of normalizing the table includes applying categorization as per the values in Table 1 below.

In normal day-to-day activity, chat may be more personal and allow for the exchange of more ideas in the interactions, as this is more often a one-to-one interaction. As a result, chats may be weighted more than the other factors. Then, meetings (e.g., audio and/or video) time may demonstrate the belonging to a community and the ability to interact. Finally, the emails may be the least weighted in the formula. This would give us after tuning the following formula to rank interactions. In an example, the variable a (e.g., corresponding to emails) may be from about 1.1 to 1.5 (e.g., 1.3), the variable b (e.g., corresponding to typed chats) may be from about 1.8 to 2.2 (e.g., 2.0), and the variable c (e.g., corresponding to meetings) may be from about 1.4 to about 1.8 (e.g., 1.6). These weights have been found to yield an optimized distance D.

The distance D may allow the method 600 to rank interactions between the first employee and other employees, and select the (e.g., 10) closest employees/colleagues. To that dimension, the technical career roles may be mapped, demonstrating the technicity and expertise of the people interacting the most with the first employee.

TABLE 1

| | 0 | 1 | 2 | 3 | 4 | 5 |
|---|---|---|---|---|---|---|
| Chat (nb) | Less than 50 | <200 | <500 | <1000 | <2000 | More than |
| Audio (h) | Less than 1 | <5 | <20 | <40 | <80 | More than |
| Video (h) | Less than 1 | <5 | <20 | <40 | <80 | More than |
| Sending | Less than 10 | <50 | <100 | <200 | <400 | More than |
| Email | | | | | | |

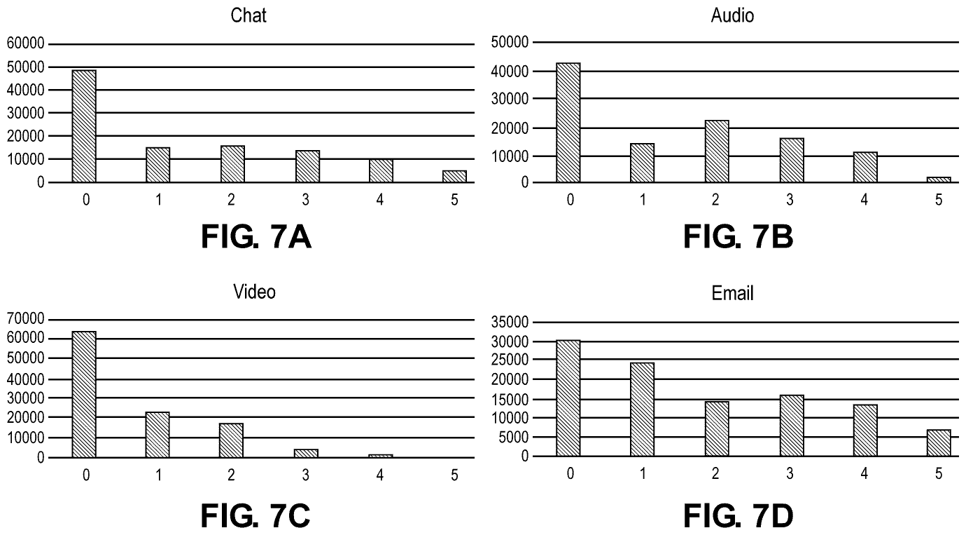

FIGS. 7A-7D illustrate graphs showing a number of users in each category in Table 1, according to an embodiment. The graphs show a relatively even distribution, which may then be used to provide a final score of the distance(s) once the coefficients a, b, and c are applied. Audio and video data, which represent meeting interactions, have been separated for the sake of the calculation and validation. These two data points may be used jointly or separately.

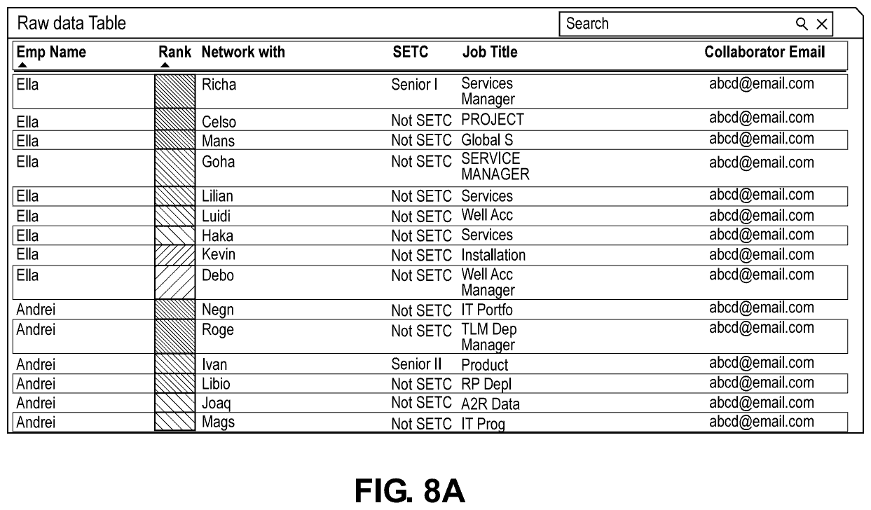

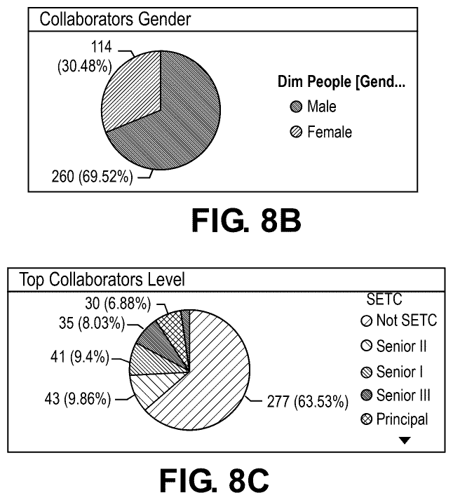

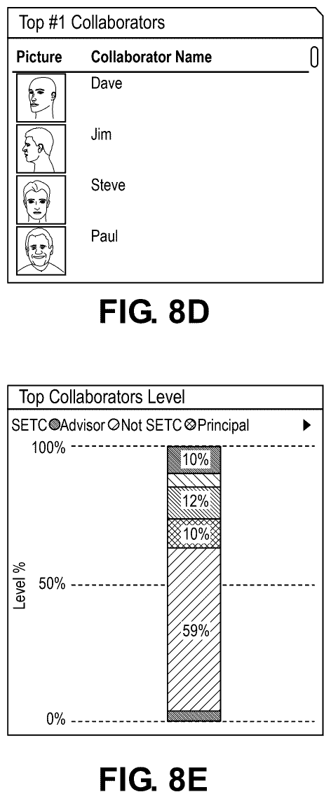

FIGS. 8A-8E illustrate displays showing a ranking of the top ten closest connections for the first employee, according to an embodiment. The displays represent the different results of the method 600. FIG. 8A shows Ella's top interactions with colleagues. The order is sorted by the “Rank” column. In this example, Ella has been interacting the most with Richa, who is Senior I. If, during the following snapshots, an evolution of the number of Senior I employees in the top list of interactions with Ella is seen, then it may indicate that she is being heard by these employees, and/or that her contribution is beginning to matter in that group of Senior I. Therefore, she should belong to that expertise group because she is recognized by her peers to have the level. FIG. 8B is a control graph, which does not interfere with the method 600. FIG. 8 C is a graph that represents the proportion of each expertise level represented in a network. This is a control for the method 600 and helps to assess the evolution of that network toward a richer level of expertise of the group. FIG. 8D is an example of an interface for the employee to have visibility of their network and closest collaborations. FIG. 8E is another way of representing FIG. 8C.

In FIGS. 8A-8E, tt may be seen that “Ella” is networking with 9 colleagues ranked from 1 to 9. For each of these colleagues, the technical career level in that case, 1 close colleague is at a senior I level. Over the course of the next 6 months, the interest may be to see if Ella increases her number of Senior I or higher within her close circle. This would show that she has been accepted by that community, and she has progressed naturally to be more technical, more heard, and grew her competencies as her voice would have more weight.

Referring back to FIG. 6, the method 600 may also include generating a first visualization of the interaction intensity during the first time period, as at 625. Examples of the first visualization may be found in FIGS. 2 and 3. The first visualization may show the first distance between the first and second employees. The interaction intensity may be represented by points. The technical skill levels of the employees may be represented by indicators (e.g., batteries) in the first visualization. In another embodiment, the first visualization may be or include numerical weights on a matrix.

The method 600 may also include determining the interaction intensity between the employees during the second time period based upon the interaction data, as at 630. The interaction intensity between the first and second employees during the second time period may be represented by a second distance between the first and second employees.

The method 600 may also include generating a second visualization of the interaction intensity during the second time period, as at 635. An example of the second visualization may be found in FIG. 4. The interaction intensity between the first employee and the other employees may be represented by distances between the first employee and the other employees in the second visualization. The interaction intensity may also or instead be represented by points.

The technical skill levels of the employees may be represented by indicators in the second visualization. In another embodiment, the second visualization may be or include numerical weights on a matrix.

The method 600 may also include comparing the interaction intensity during the first time period to the interaction intensity during the second time period, as at 640. Comparing the interaction intensity may include comparing the distances between the first employee and the other employees in the first visualization to the distances between the first employee and the other employees in the second visualization. Comparing the interaction intensity may also or instead include comparing the indicators of the other employees in the first visualization to the indicators of the other employees in the second visualization.

The method 600 may also include performing an action in response to the patent data, the interaction intensity between the employees during the second time period, the second visualization, the comparison, or a combination thereof, as at 645. The action may include generating or transmitting a signal or notification that recommends, instructs, or causes the technical skill structure to be updated. The technical skill structure may be updated to promote or demote the first employee to a different employment level. In an example, promoting or demoting the first employee may include automatically adjusting an ability of the first employee to enter a building or access technical information stored in a database.

### Exemplary Computing System

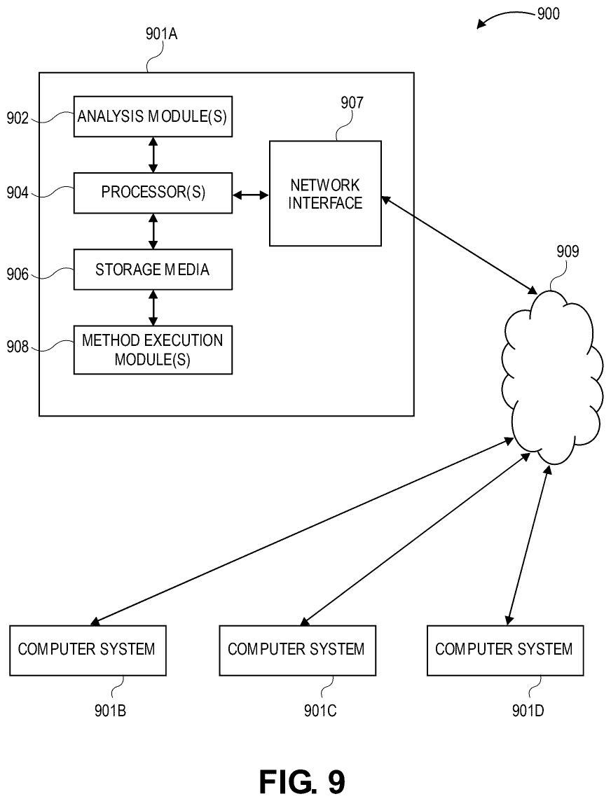

In some embodiments, the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis modules 902 that are configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor may include a microprocessor, microcontroller, processor module or subsystem, programmable integrated circuit, programmable gate array, or another control or computing device.

The storage media 906 may be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 900 contains one or more method execution module(s) 908. In the example of computing system 900, the computer system 901A includes the method execution module 908. In some embodiments, a single method execution module may be used to perform some aspects of one or more embodiments of the methods disclosed herein. In other embodiments, a plurality of method execution modules may be used to perform some aspects of methods herein.

It should be appreciated that computing system 900 is merely one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the subsurface three-dimensional geologic formation under consideration.

The foregoing description, for purposes of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for helping to assess an employment level or a level of progression of an employee within an organization, the method comprising:
receiving a technical skill structure of an organization, wherein the technical skill structure comprises different employment levels and/or different levels of progression in the organization, and wherein the organization comprises a plurality of employees that are assigned to the different employment levels and/or the different levels of progression;
receiving interaction data representing interactions between the employees, wherein the interactions occur while the employees perform one or more duties for the organization; and
determining an interaction intensity between the employees during a first time period based upon the interaction data.

2. The method of claim 1, wherein the employees each have a technical skill level, and wherein at least some of the employees are assigned to one of the employment levels and/or the levels of progression based upon their respective technical skill levels.

3. The method of claim 1, wherein the employees comprise at least a first employee and a second employee, and wherein the second employee is assigned to a different employment level or a different level of progression than the first employee.

4. The method of claim 3, wherein the interactions comprise in-person interactions and/or digital interactions, wherein the in-person interactions comprise meetings, and wherein the digital interactions comprise emails and/or typed chats.

5. The method of claim 4, wherein the interaction intensity between the first employee and the second employee during the first time period is represented by a first distance between the first and second employees, and wherein the interaction intensity between the first and second employees during a second time period is represented by a second distance between the first and second employees.

6. The method of claim 5, wherein the first distance is based upon a number of the emails sent from the first employee to the second employee, a number of the typed chats sent from the first employee to the second employee, a number of hours of the meetings where the first and second employees are both present, or a combination thereof.

7. The method of claim 6, further comprising comparing the interaction intensity during the first time period to the interaction intensity during the second time period, wherein an action is performed based upon or in response to the comparison.

8. The method of claim 7, wherein comparing the interaction intensity comprises comparing the first distance to the second distance.

9. The method of claim 1, further comprising generating a visualization of the interaction intensity during the first time period.

10. The method of claim 1, further comprising performing an action in response to the interaction intensity, wherein the action comprises updating the technical skill structure to promote or demote the first employee to one of the different employment levels or the different levels of progression.

11. A computing system, comprising:
one or more processors; and
a memory system comprising one or more non-transitory computer-readable media storing instructions that, when executed by at least one of the one or more processors, cause the computing system to perform operations, the operations comprising:
receiving a technical skill structure of an organization, wherein the technical skill structure comprises different employment levels, wherein the organization comprises a plurality of employees including at least a first employee and a second employee, wherein the employees each have a technical skill level, wherein at least some of the employees are assigned to one of the employment levels based upon their respective technical skill levels;
receiving interaction data representing interactions between the employees, wherein the interactions occur while the employees perform one or more duties for the organization, wherein the interactions comprise in-person interactions and/or digital interactions, wherein the in-person interactions comprise meetings, wherein the digital interactions comprise emails and/or typed chats, and wherein the interactions occur during a first time period and a second time period;
determining an interaction intensity between the employees during the first time period based upon the interaction data, wherein the interaction intensity between the first and second employees during the first time period is represented by a first distance between the first and second employees, and wherein the first distance is based upon a number of the emails sent from the first employee to the second employee, a number of the typed chats sent from the first employee to the second employee, and a number of hours of the meetings where the first and second employees are both present;
determining the interaction intensity between the employees during the second time period based upon the interaction data, wherein the interaction intensity between the first and second employees during the second time period is represented by a second distance between the first and second employees,
comparing the interaction intensity during the first time period to the interaction intensity during the second time period, wherein comparing the interaction intensity comprises comparing the first distance in the first visualization to the second distance in the second visualization; and
performing an action in response to the interaction intensity between the employees during the second time period, the comparison, or a combination thereof.

12. The computing system of claim 11, wherein the operations further comprise:
generating a first visualization of the interaction intensity during the first time period, wherein the first visualization shows the first distance between the first and second employees, wherein the technical skill levels of the employees are represented by indicators in the first visualization; and
generating a second visualization of the interaction intensity during the second time period, wherein comparing the interaction intensity comprises comparing the indicators in the first visualization to the indicators in the second visualization.

13. The computing system of claim 11, wherein the first distance is also based upon a first coefficient corresponding to the number of the emails, a second coefficient corresponding to the number of the typed chats, and a third coefficient corresponding to the number of hours of the meetings.

14. The computing system of claim 13, wherein the second coefficient is greater than the first coefficient, and wherein the third coefficient is between the first and second coefficients.

15. The computing system of claim 14, wherein the number of the emails, the number of the typed chats, and the number of hours of the meetings are normalized based upon a distribution of the interaction data.

16. A non-transitory computer-readable medium storing instructions that, when executed by one or more processors of a computing system, cause the computing system to perform operations, the operations comprising:
receiving a technical skill structure of an organization, wherein the technical skill structure comprises different employment levels, wherein the organization comprises a plurality of employees including at least a first employee, a second employee, and other employees, wherein the employees each have a technical skill level, wherein at least some of the employees are assigned to one of the employment levels based upon their respective technical skill levels, and wherein the other employees are assigned to a higher employment level than the first employee;
receiving interaction data representing interactions between the employees, wherein the interactions occur while the employees perform one or more duties for the organization, wherein the interactions comprise in-person interactions and digital interactions, wherein the in-person interactions comprise meetings, wherein the digital interactions comprise emails and typed chats, and wherein the interactions occur during a first time period and a second time period;
receiving patent data representing a number of patent applications or patents where each of the employees is listed as an inventor;
determining an interaction intensity between the employees during the first time period based upon the interaction data, wherein the interaction intensity between the first and second employees during the first time period is represented by a first distance between the first and second employees, wherein the first distance is determined using:
$$D = a * X + b * Y + c * Z$$
where D is the first distance, X is a number of the emails sent from the first employee to the second employee, Y is a number of the typed chats sent from the first employee to the second employee, Z is a number of hours of the meetings where the first and second employees are both present, a is a first coefficient, b is a second coefficient that is greater than the first coefficient, and c is a third coefficient that is between the first and second coefficients, wherein X, Y, and Z are normalized based upon a distribution of the interaction data;
generating a first visualization of the interaction intensity during the first time period, wherein the first visualization shows the first distance between the first and second employees, and wherein the technical skill levels of the employees are represented by indicators in the first visualization;
determining the interaction intensity between the employees during the second time period based upon the interaction data, wherein the interaction intensity between the first and second employees during the second time period is represented by a second distance between the first and second employees,
generating a second visualization of the interaction intensity during the second time period;
comparing the interaction intensity during the first time period to the interaction intensity during the second time period, wherein comparing the interaction intensity comprises comparing the first distance in the first visualization to the second distance in the second visualization, and wherein comparing the interaction intensity comprises comparing the indicators in the first visualization to the indicators in the second visualization; and
performing an action in response to the patent data, the interaction intensity between the employees during the second time period, the second visualization, and the comparison.

17. The non-transitory computer-readable medium of claim 16, wherein a is from about 1.1 to about 1.5, wherein b is from about 1.8 to about 2.2, and wherein c is from about 1.4 to about 1.8.

18. The non-transitory computer-readable medium of claim 16, wherein the action comprises generating or transmitting a signal or notification that recommends, instructs, or causes the technical skill structure to be updated.

19. The non-transitory computer-readable medium of claim 18, wherein the technical skill structure is updated to promote or demote the first employee to a different employment level.

20. The non-transitory computer-readable medium of claim 19, wherein promoting or demoting the first employee comprises automatically adjusting an ability of the first employee to enter a building or access technical information stored in a database.
